(19) United States
(12) Patent Application Publication
(10) Pub. No.: US 2019/0001902 A1
(43) Pub. Date: Jan. 3, 2019

(54) FLEX BUTTON SYSTEM

(71) Applicant: Faraday&Future Inc., Gardena, CA (US)

(72) Inventors: R. Stewart Kern, Redondo Beach, CA (US); Adam Paul Ruddle, Hermosa Beach, CA (US); Taeho Kim, Los Angeles, CA (US); Pontus Anthony Fontaeus, Newport Beach, CA (US)

(21) Appl. No.: 15/691,674

(22) Filed: Aug. 30, 2017

Related U.S. Application Data
(60) Provisional application No. 62/382,124, filed on Aug. 31, 2016.

(51) Int. Cl. B60R 13/02; B60J 5/04

(52) U.S. Cl. CPC B60R 13/0243; E05F 15/00; B60J 5/0493

(57) ABSTRACT

A flex button system is disclosed. The system may comprise a top panel. The top panel may comprise one or more cut-through openings and one or more flaps. At least one side of the flap may be edged by the cut-through opening. The flap may be configured to flex with respect to the top panel, in response to a press of the flap. At least one of the one or more cut-through openings may be configured to accommodate one or more fingers.

### CROSS-REFERENCE TO RELATED APPLICATIONS

This application claims the benefit of U.S. Provisional Application No. 62/382,124, filed Aug. 31, 2016, the entirety of which is hereby incorporated by reference.

### TECHNICAL FIELD

The present disclosure relates generally to flex button systems, and more particularly, to vehicle flex button systems.

### BACKGROUND

Existing vehicle window switches are mostly hinge or pivot-based, which become incompatible with sleek interior designs of modern vehicles. Such hinge or pivot mechanics disrupt smooth surfaces of the interior of vehicle doors. Therefore, it is desirable to replace such switches with new systems that can detect press actions without unseemly movement of a button.

### SUMMARY

One aspect of the present disclosure is directed to a flex button system. The system may comprise a top panel. The top panel may comprise one or more cut-through openings and one or more flaps. At least one side of the flap may be edged by the cut-through opening. The flap may be configured to flex with respect to the top panel, in response to a press of the flap. At least one of the one or more cut-through openings may be configured to accommodate one or more fingers.

Another aspect of the present disclosure is directed to a vehicle. The vehicle may comprise a top panel on a door of the vehicle. The top panel may comprise one or more cut-through openings and one or more flaps. The at least one side of the flap may be edged by the cut-through opening. The flap may be configured to flex with respect to the top panel, in response to a press of the flap. At least one of the one or more cut-through openings may be configured to accommodate one or more fingers.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a block diagram illustrating a vehicle system for implementing flex button system, consistent with exemplary embodiments of the present disclosure.

FIGS. 2A-2G are graphical representations illustrating various components of a flex button system, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Existing vehicle window switches cannot meet the design requirements for an integrated and smooth vehicle interior. The disclosed systems can combine the simplicity of human-interface switches and the visual appearance of a continuous surface. The disclosed systems may mitigate or overcome one or more of the problems set forth above and/or other problems in the prior art.

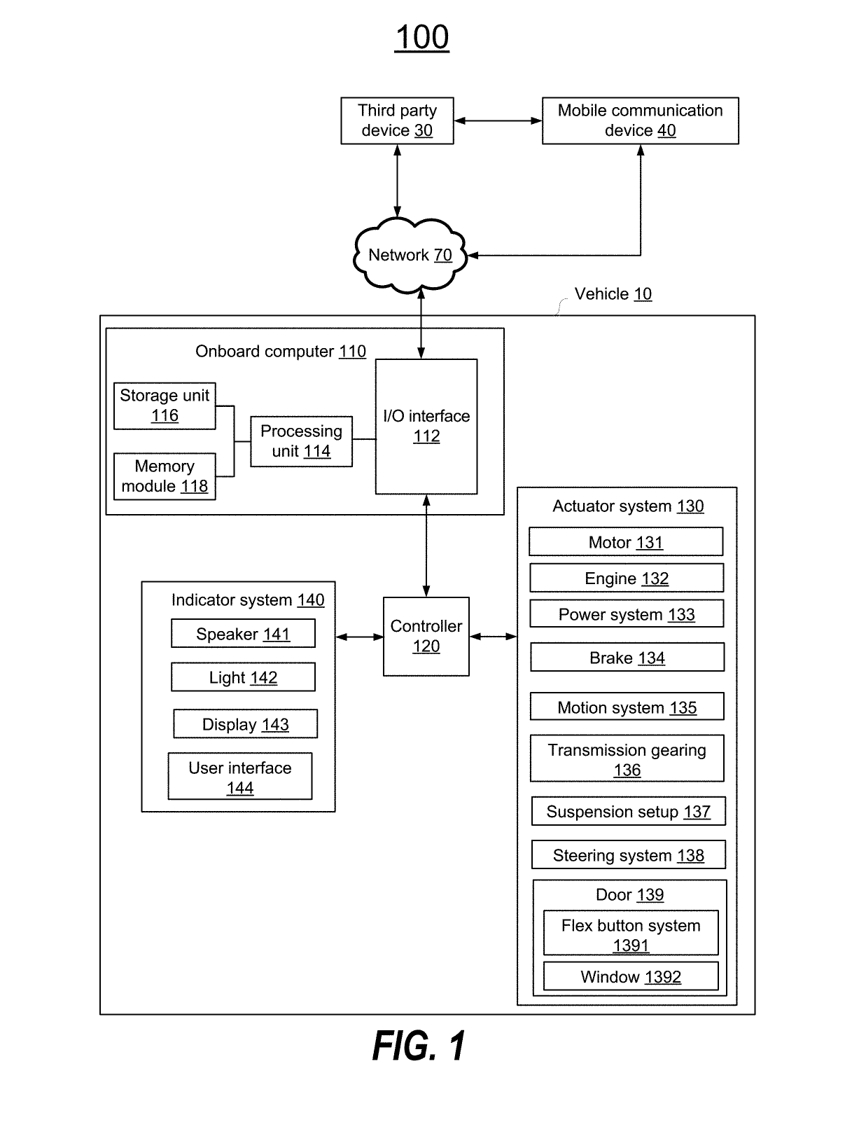

FIG. 1 is a block diagram illustrating a vehicle system 100 for implementing flex button system 1391, consistent with exemplary embodiments of the present disclosure. System 100 may comprise a number of components and sub-components, some of which may be optional. However, it is not necessary that all of these components be shown in order to disclose an illustrative embodiment.

As illustrated in FIG. 1, system 100 may include a vehicle 10 and one or more external devices connected via network 70. The external devices may include a third party device 30 and a mobile communication device 40. Network 70 may be optional.

Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous.

Vehicle 10 may be in communication with a plurality of devices, such as third party device 30 and mobile communication device 40. Mobile communication device 40 may include a smart phone, a tablet, a personal computer, a wearable device, such as a smart watch or Google Glass™, and/or complimentary components. Mobile communication device 40 may be configured to connect to a network, such as a nationwide cellular network, a local wireless network (e.g., Bluetooth™ or WiFi), and/or a wired network. Mobile communication device 40 may also be configured to access apps and websites of third parties, such as iTunes™, Google™, Facebook™, Yelp™, or other apps and websites associated with vehicle 10. Vehicle 10, third party device 30, and mobile communication device 40 may store and share data and information, such as a profile of vehicle 10 (e.g., the year, make, model, and owner of a vehicle).

In some embodiments, mobile communication device 40 may be carried by or associated with one or more users of vehicle 10. For example, vehicle 10 may be configured to determine the identity of a user based on a digital signature or other identification information from mobile communication device 40. For instance, processing unit 114 of vehicle 10 may be configured to relate the digital signature to stored profile data including the person's name and the person's relationship with vehicle 10. The digital signature of mobile communication device 40 may include a determinative emitted radio frequency (RF) or a global positioning system (GPS) tag. Mobile communication device 40 may be configured to automatically connect to or be detected by vehicle 10 through local network 70.

Third party device 30 may include smart phones, personal computers, laptops, pads, servers, and/or processors of third parties. Third party devices 30 may be accessible to the users through mobile communication device 40 or directly accessible by vehicle 10 via network 70.

Vehicle 10 may include a specialized onboard computer 110, a controller 120, an actuator system 130, and an indicator system 140. Onboard computer 110, actuator system 130, and indicator system 140 may all connect to controller 120. Onboard computer 110 may comprise, among other things, an I/O interface 112, a processing unit/processor 114, a storage unit 116, and a memory module 118, which may transfer data and send or receive instructions among one another. Storage unit 116 and memory module 118 may be non-transitory and computer-readable and may store instructions that, when executed by processing unit 114, cause one or more components of system 100 to perform one or more methods. One or more of the components of vehicle 10 may be optional. For example, processing unit 114 may directly connect to indicator system 140, bypassing I/O interface 112 and controller 120. Therefore, it is not necessary that all of the above components be shown in order to disclose an illustrative embodiment.

I/O interface 112 may be configured for two-way communication between onboard computer 110 and various components of system 100. I/O interface 112 may send and receive operating signals to and from mobile communication device 40 and third party device 30. I/O interface 112 may send and receive the data between each of the devices via communication cables, wireless networks, or other communication mediums. For example, mobile communication device 40 and third party devices 30 may be configured to send and receive signals to I/O interface 112 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Processing unit 114 may be configured to receive signals (e.g., sensor signals from indicator system 140, or a user input from charging target 20, third party device 30, or mobile communication device 40) and process the signals to determine a plurality of conditions of the operation of vehicle 10 (e.g., operations of various components of actuator system 130). Processing unit 114 may also be configured to generate and transmit command signals, via I/O interface 112, in order to actuate other components.

Storage unit 116 and/or memory module 118 may be configured to store one or more computer programs that may be executed by onboard computer 110 to perform functions of vehicle 10. Storage unit 116 and/or memory module 118 may be configured to store information of various vehicle. Storage unit 116 and/or memory module 118 may be further configured to store data and/or look-up tables used by processing unit 114.

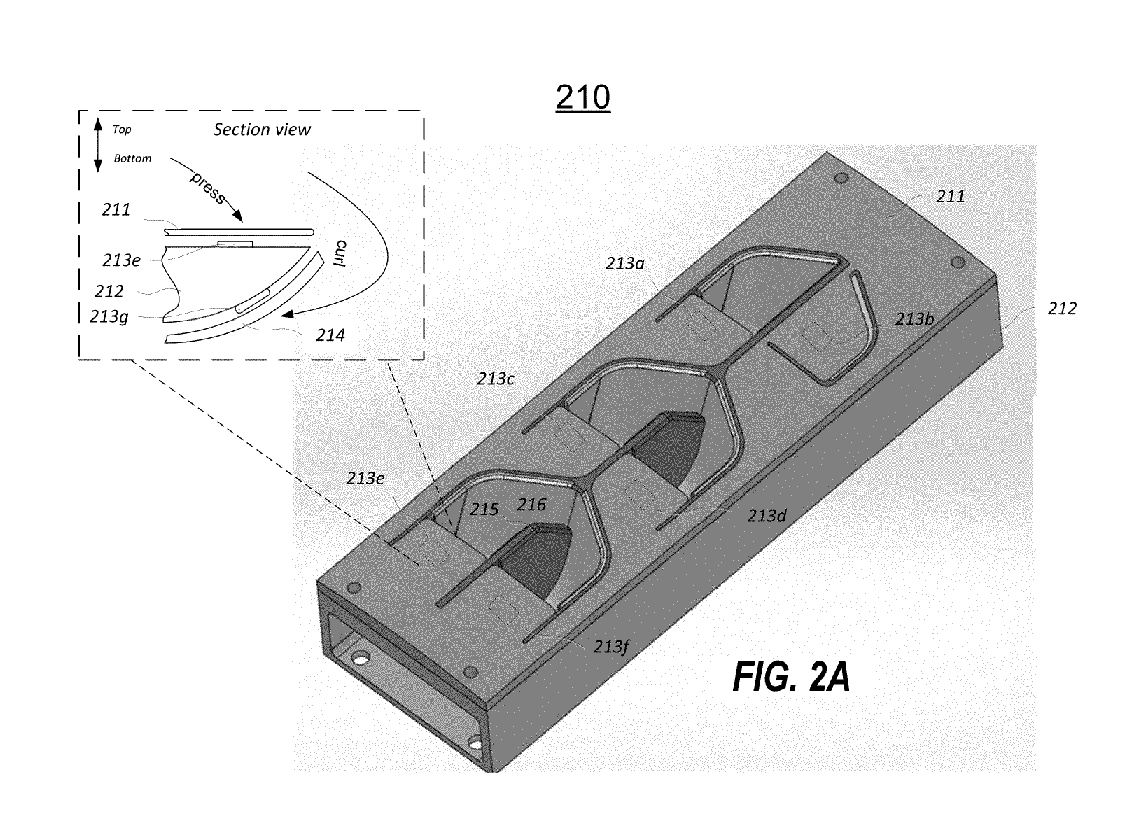

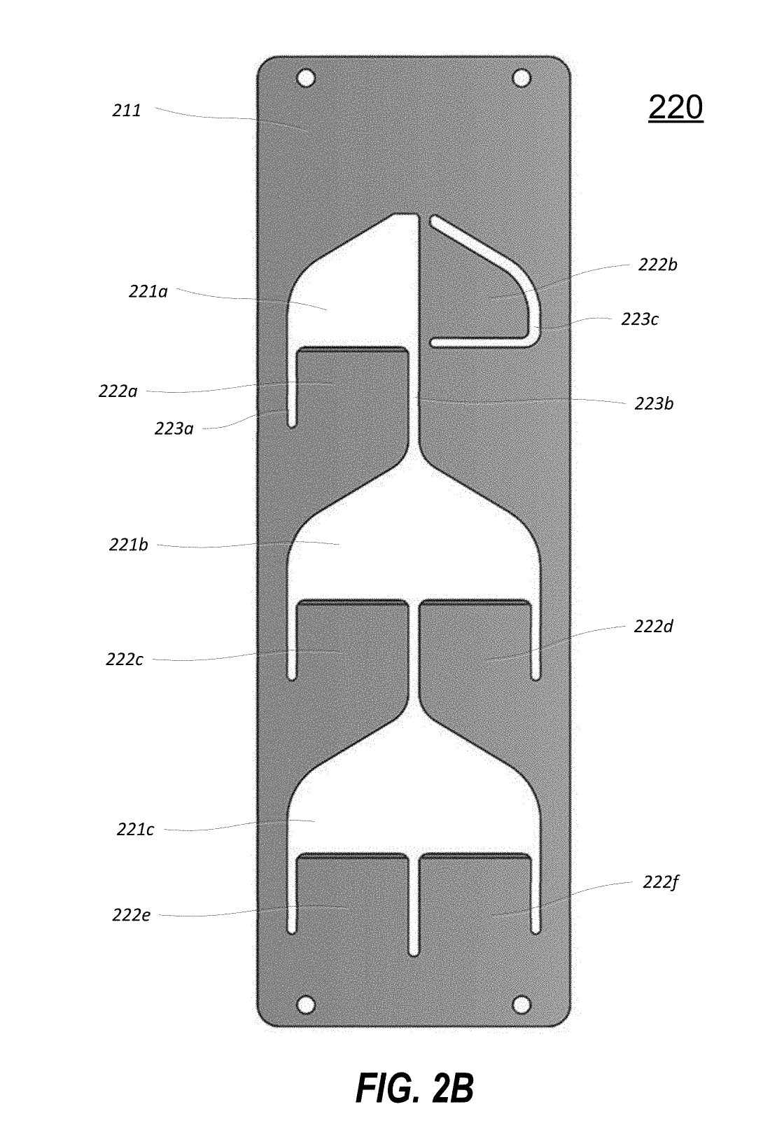

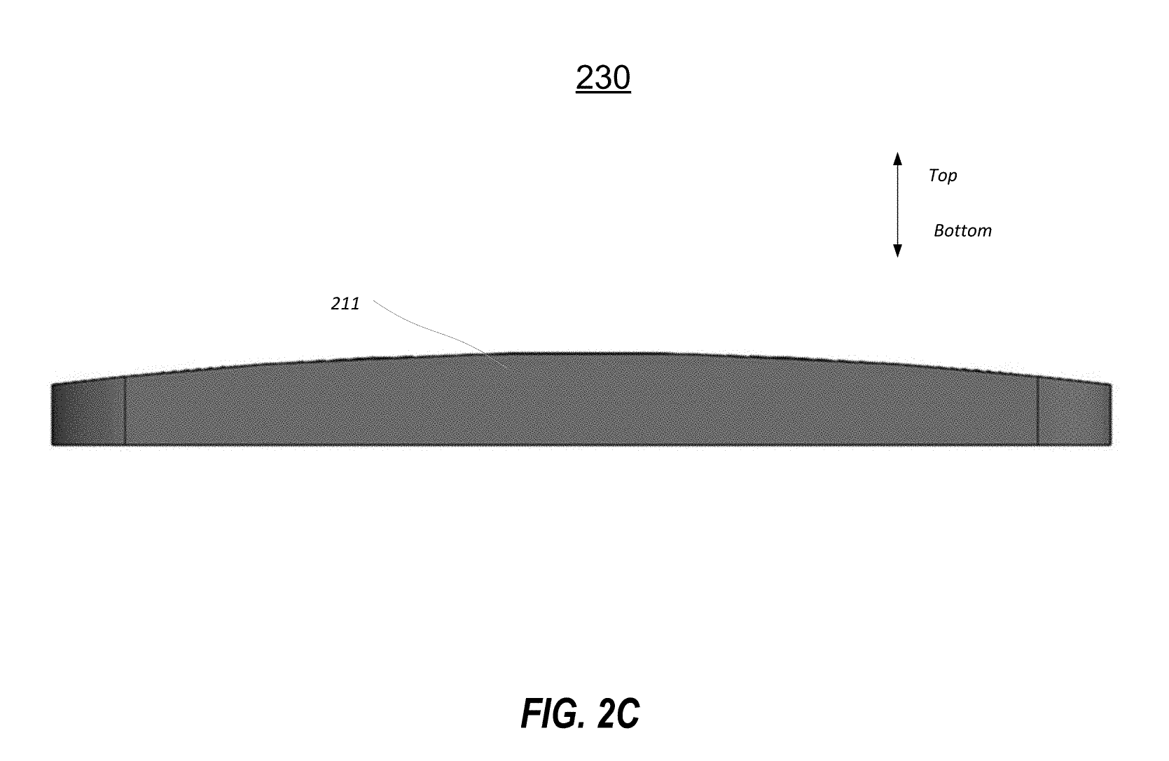

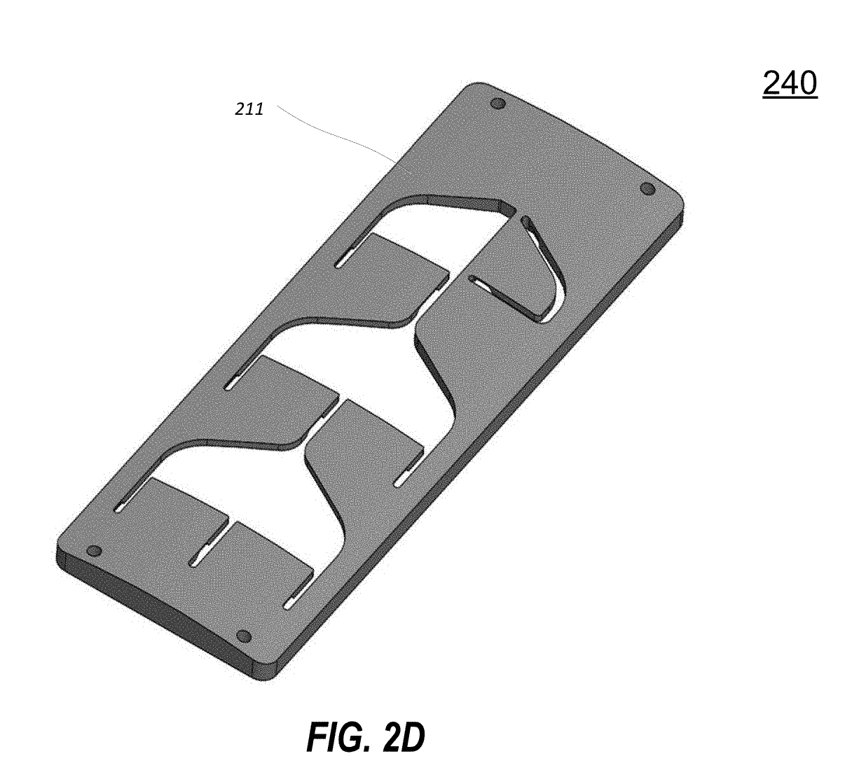

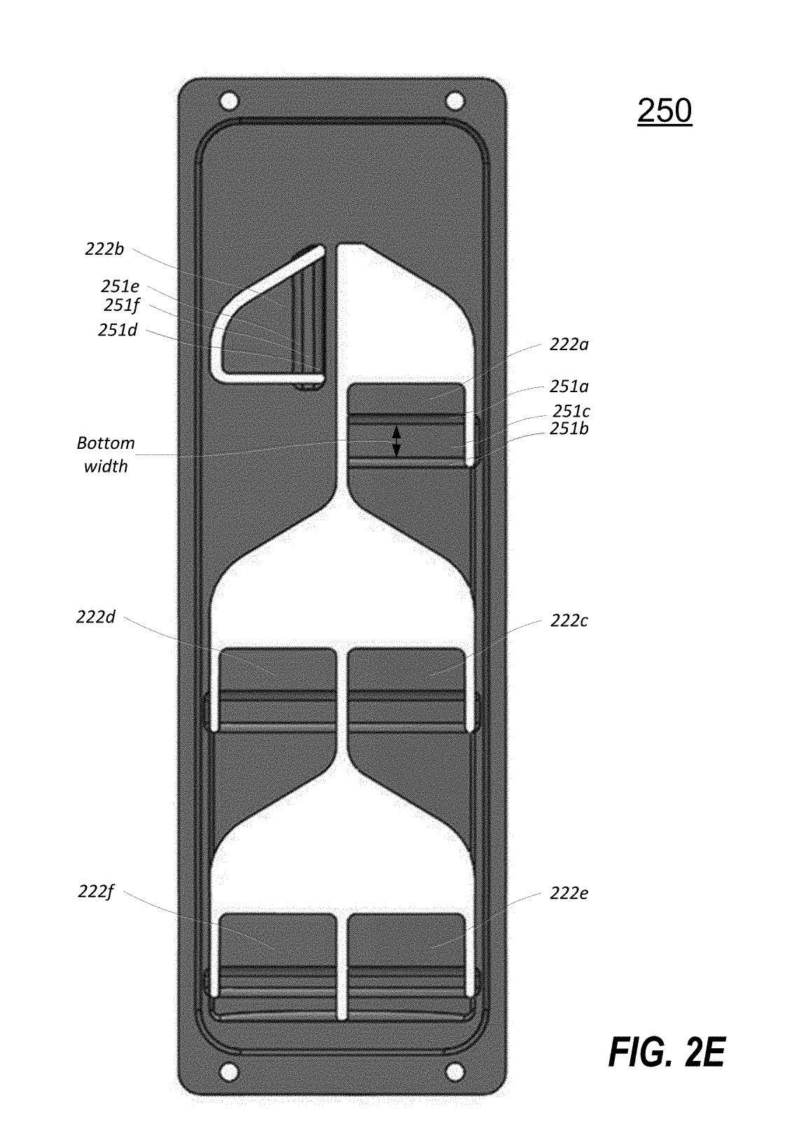

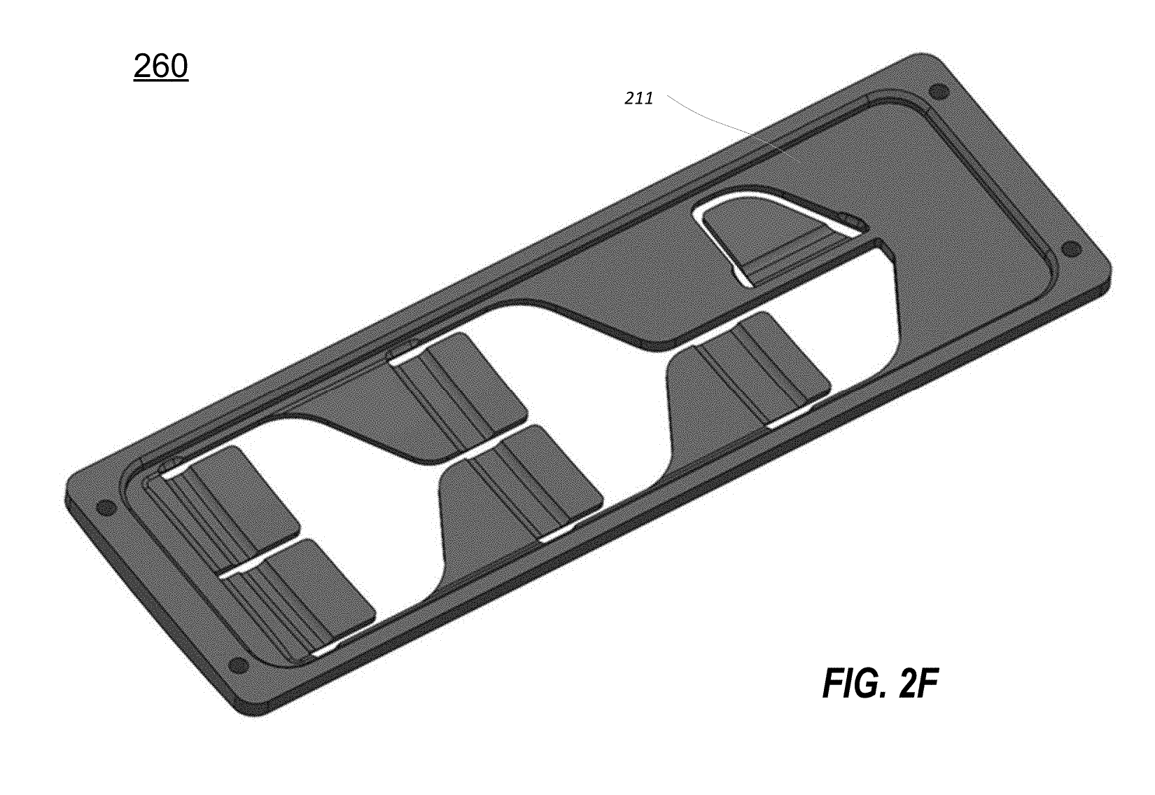

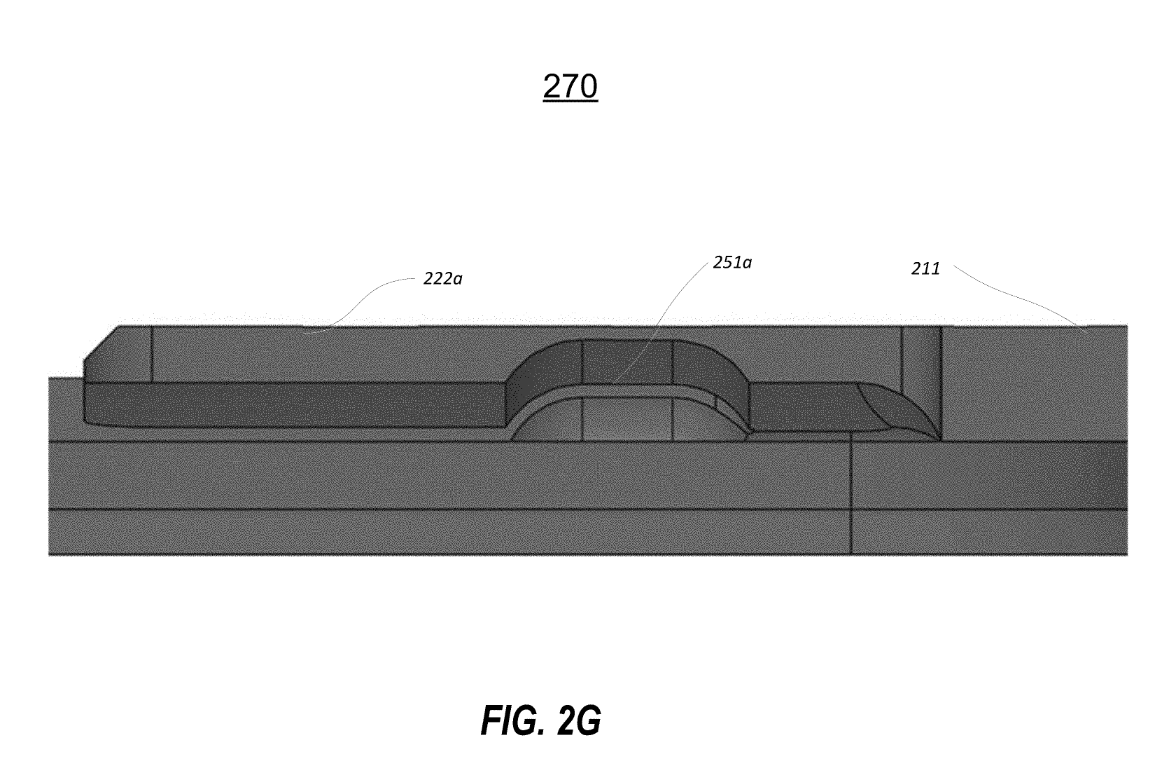

Vehicle 10 may also include a controller 120 connected to onboard computer 110 and capable of controlling one or more aspects of operation of vehicle 10. In some examples, controller 120 is connected to one or more actuator systems 130 and one or more indicator systems 140. One or more actuator systems 130 may include, but are not limited to, a motor 131, an engine 132, a power system 133, a brake 134, a motion system 135, a transmission gearing 136, a suspension setup 137, a steering system 138, and one or more doors 139. Onboard computer 110 may control, via controller 120, one or more components of the actuator systems 130 during operation. One or more doors 139 may comprise a flex button system 1391 described below with reference to FIGS. 2A-2G and one or more windows 1392. Flex button system 1391 may be configured to receive a user input and actuate window 1392. Flex button system 1391 may also be implemented as other positions in a vehicle or on other devices to actuate one or more other components. Although this disclosure focuses on actuating windows with the flex button system, its applications and implementations are not limited by the exemplary embodiments.

The one or more indicator systems 140 can include, but are not limited to, one or more speakers 141, one or more lights 142, one or more displays 143, and one or more user interfaces 144. Onboard computer 100 can control, via controller 120, one or more of the indicator systems 140 to provide indications of the vehicle, the vehicle's surroundings or another vehicle, to receive instructions, and/or to provide information. Display 143 may be disposed at various locations at vehicle 10. Display 143 may be configured to display information related to the vehicle, such as vehicle profile, battery information, access control, and etc.

User interface 144 may be configured to receive inputs from users or devices and to transmit data. For example, user interface 144 may have a display including an LCD, an LED, a plasma display, or any other type of display, and provide a graphical user interface (GUI) presented on the display for user input and data display. User interface 144 may further include speakers or other voice playing devices. User interface 144 may further include input devices, such as a touchscreen, a keyboard, a mouse, a microphone, and/or a tracker ball, to receive a user input. User interface 144 may also connect to a network to remotely receive instructions or user inputs. Thus, the input may be directly entered by a user, captured by user interface 144, or received by user interface 144 over the network.

User interface 144 may also be configured to receive user-defined settings. For example, user interface 144 may be configured to receive user profiles including, for example, an age, a gender, a driving license status, frequent destinations, vehicle charging frequencies, vehicle charging stations, and etc. In some embodiments, user interface 144 may include a touch-sensitive surface configured to receive biometric data (e.g., detect a fingerprint of a user). The touch-sensitive surface may be configured to detect the ridges and furrows of a fingerprint based on a change in capacitance and generate a signal based on the detected fingerprint, which may be processed by processing unit 114. Processing unit 114 may be configured to compare the signal with stored data to determine whether the fingerprint matches recognized users. Vehicle 10 may also be able to connect to the Internet, obtain data from the Internet, and compare the signal with obtained data to identify the users. User interface 144 may be configured to include biometric data into a signal, such that processing unit 114 can identify the person generating the input. User interface 144 may also compare a received voice input with stored voices to identify the person generating the input. Furthermore, user interface 144 may be configured to store data history accessed by the identified person. Based on the identities, processing unit 114 may grant or decline access to use one or more batteries associated with the vehicle.

In some embodiments, user interface 144 may include one or more electrophysiological sensors for encephalography-based autonomous driving. For example, an electrophysiological sensor may detect electrical activities of brains of the user(s) and convert the electrical activities to signals, such that processing unit 114 can execute a corresponding command.

FIGS. 2A-2G are graphical representations 210-270 illustrating various components of flex button system 1391, consistent with exemplary embodiments of the present disclosure. Flex button system 1391 may be integrated into any part of vehicle 10 described above or another device. For example, flex button system 1391 may be disposed on an inside of a vehicle door, a dashboard, or on a center console of a vehicle, and may be configured to actuate one or more components such as windows of the vehicle. However, the application of the flex button system 1391 is not limited to vehicles.

FIG. 2A is a graphical representation 210 illustrating flex button system 1391, consistent with exemplary embodiments of the present disclosure. Flex button system 1391 may comprise a top panel 211 and a bottom panel 212. Both panels 211 and 212 may be made of metal, plastic, or another material. In some embodiments, panel 211 is made of aluminum, metal alloy, or stainless steel. The shapes and characteristics of panel 211 will be described in more details below. In some embodiments, flex button system 1391 may be implemented in a vehicle, e.g., on a vehicle door, a center console, a dashboard, or the like, for window control.

Panel 212 may comprise one or more sensors 213a-213g, e.g., pressure sensors or tactile switches configured to trigger one or more signals based on a detected touch or pressure from top panel 211. Since panel 211 covers panel 212, as shown in FIG. 2A, sensors 213a-213f are correspondingly covered by various parts of panel 211. These parts, referred to as “flaps,” are bendable or flexible, causing the detected pressure by the sensors, and will be described in more details below.

Panel 212 may have a box shape overall and comprise depression areas, such as cavity 216 on top. The depression areas may fit or match with openings on panel 211, such that, for example, a finger may reach into the depression area. Cavity 216 may be divided by a divider 215 into a left and a right depression areas, such that the left and right depression areas are each hosting one sensor and are each configured to accommodate one finger. In some embodiments, a light strip is routed within divider 215 and used to provide illumination to both left and right depression areas.

A left depression area is illustrated in an exploded section view in FIG. 2A. As shown in the section view, panel 211 is disposed on panel 212, which comprises sensor 213e, sensor 213g, and flap 214. Sensor 213e may be disposed between panel 211 and a top surface of panel 212, such that sensor 213e can detect pressure exerted on panel 211. Similarly, sensor 213g may be disposed between flap 214 and a slope surface of panel 212, such that sensor 213g can detect pressure exerted on flap 214. Combining both perspectives above, a finger pressing on 211 above 213e may trigger signal readings at sensor 213e, and a finger curled and pressing on 214 next to 213g may trigger signal readings at sensor 213g. Panel 211 and flap 214 may be connected to form one piece of component or be separated.

In some embodiments, sensor 213e may be configured to control a down motion of a driver side rear window, sensor 213g may be configured to control a up motion of the driver side rear window. Similar to sensor 213e, sensor 213f may be configured to control a down motion of a passenger side rear window, sensor 213d may be configured to control a down motion of a passenger side front window, sensor 213c may be configured to control a down motion of a driver side front window, sensor 213b may be configured to lock or unlock all windows of a vehicle, and sensor 213a may be configured to control a down motion of all windows of the vehicle.

FIG. 2B is a graphical representation 220 illustrating a top surface of panel 211, consistent with exemplary embodiments of the present disclosure. Panel 211 may be one continuous piece with one or more cut-through openings of various shapes. For example, main opening 221a may be large enough to accommodate a finger, e.g., an average adult's index finger. Main opening 221b and main opening 221c may each accommodate two fingers: a finger on its left half and another finger on its right half. Accommodating a finger here may referring to allowing a finger to insert through the opening and reach underneath, e.g., to trigger another sensor to move up a window. Main openings 221a, 221b, and 221c may be connected by strip openings, such as opening 223b. Some strip openings may extend from the main openings, such as trip opening 223a extending from main opening 221a. By such configuration, flap 222a is formed from panel 211, with one side connected to other parts of panel 211 and three other sides surrounded by strip opening 222a, main opening 221a, and strip opening 223b. That is, at least one side of flap 222a is edged by the cut-through opening. This configuration may allow flap 222a to be pressed down easily to trigger associated sensors underneath, while retaining an overall smooth surface. That is, flap 222a is configured to flex with respect to the top panel, in response to a press of the flap. In some embodiments, flap 222a may have a substantially rectangular shape with three sides edged by the cut-through openings. Flap 222a may also restore to its equilibrium position as soon as the press is released. The downward pressure may be registered by a pressure sensor underneath to trigger one or more signals, e.g., for moving down a window. In some embodiments, it may be important that panel 211 is one single continuous piece of material, without disrupting the surface smoothness and continuation, to provide an ergonomic control panel. The strip openings may be sealed with plastic or other materials to prevent debris from accumulating in the panel, while still allowing the flap movement. Similarly, flaps 222c-222f may be formed. Flap 222b may serve a similar function as other flaps, but with a modified configuration. A curved strip opening 223c may be cut from piece 211 to form flap 222b, leaving one side of flap 222b connected to the other parts of panel 211. That is, all flaps may have all but one side cut loose from panel 211 to allow flexing with respect to the one side. Thus, pressing on flap 222b can be registered similarly by an associated sensor. Since flap 222b may be used for toggling between locking and unlocking all windows. It may not require a window roll up function, nor a main opening for a finger to reach underneath to trigger another sensor. In some embodiments, flaps 222a and 222c-222f may not be configured to toggle between rolling up and down windows with one press button.

In some embodiments, curved strip opening 223c is illuminated by internal lighting. Internal lighting may be provided by one or more LEDs installed within the depression areas. Internal lighting may also be provided by a light strip installed within divider 215.

FIG. 2C is a graphical representation 230 illustrating a side view of panel 211 from a shorter edge, consistent with exemplary embodiments of the present disclosure. Across this side view, panel 211 may have an increasing thickness towards the vertical center, for the ease of touch feeling.

FIG. 2D is a graphical representation 240 illustrating a perspective view of panel 211, consistent with exemplary embodiments of the present disclosure. Graphical representation 240 illustrates a 3D structure of panel 211 in one perspective focusing on its top surface.

FIG. 2E is a graphical representation 250 illustrating a bottom surface of panel 211, consistent with exemplary embodiments of the present disclosure. As shown in FIG. 2E, flaps 222a-222f each have a relief cut or groove. For example, parts 251a-251c form a groove of flap 222a, and parts 251d-251f form a groove of flap 222b. In this case, parts 251a and 251b are slopes leading to a flat bottom 251c of the groove. In some other embodiments, the bottom may have a circular cross-section. In some embodiments, the grooves of at least two flaps may have different widths. For example, as shown in FIG. 2E, the width of the groove may increase from bottom flaps 222f, 222e, to middle flaps 222d, 222c, and to top flap 222a. The bottom flaps may be associated with rear windows, the middle flaps may be associated with front windows, and the top flap may be associated with all windows. In some other embodiments, flaps 222a-222f each may have two or more relief cuts or grooves. For example, flap 222a has two parallel relief cuts. The relief cuts can facilitate flex actions of the flaps by thinning one or more parts of the flaps, e.g., at areas connecting to unmoving parts of panel 211. The relief cuts or grooves may have a round or square bottom. In some embodiments, the relief cut or groove is about 0.8 mm deep, the flap thickness outside the relief cut and groove is about 1.2 mm, and the flap thickness at the relief cut or groove is about 0.4 mm.

FIG. 2F is a graphical representation 260 illustrating a perspective view of panel 211, consistent with exemplary embodiments of the present disclosure. Graphical representation 260 illustrates a 3D structure of panel 211 in another perspective focusing on its bottom surface. Panel 211, including the openings and grooves described above, may be molded (e.g., stamped) or cut from a piece of material, such as aluminum, alloy, or stainless steel.

FIG. 2G is a graphical representation 270 illustrating a section view of panel 211, consistent with exemplary embodiments of the present disclosure. Flap 222a may flex with respect to panel 211. The flex action is facilitated by relief cut 251a.

As described above, the disclosed flex button systems can replace many discrete parts of hinge or pivot buttons with one piece of material, and are more cost-efficient. With a proper geometric design, the flex button system can last longer than hinge or pivot buttons. Further, the disclosed flex button systems can provide ergonomically smooth surfaces in switch panels to enhance an overall sleek interior design of vehicles.

The specification has described flex button systems. The illustrated structures and steps are set out to explain the exemplary embodiments shown, and it should be anticipated that ongoing technological development will change the structures and the manner in which particular functions are performed. Thus, these examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A flex button system, comprising:
a top panel, wherein:
the top panel comprises one or more cut-through openings and one or more flaps;
at least one side of the flap is edged by the cut-through opening;
the flap is configured to flex with respect to the top panel, in response to a press of the flap; and
at least one of the one or more cut-through openings is configured to accommodate one or more fingers.

2. The system of claim 1, wherein the flap has all but one side cut loose from the top panel.

3. The system of claim 2, wherein the flap is configured to flex with respect to the one side.

4. The system of claim 1, wherein the cut-through openings comprise one or more main openings and one or more strip openings.

5. The system of claim 4, wherein the main openings are connected with the strip openings.

6. The system of claim 4, wherein the flap has a substantially rectangular shape with three sides edged by the cut-through openings.

7. The system of claim 4, wherein the flap is edged by two strip openings on two sides and the cut-through opening on another side.

8. The system of claim 1, wherein the flap comprise one or more grooves on a bottom surface of the flap.

9. The system of claim 8, wherein the one or more flaps include multiple flaps each including a groove, and the grooves of at least two flaps have different widths.

10. The system of claim 1, further comprising a bottom panel disposed below the top panel.

11. The system of claim 10, wherein the bottom panel comprises one or more depressions on its top surface, at least one of the depressions matching at least one of the cut-through openings.

12. The system of claim 10, wherein the bottom panel comprises a first sensor on its top surface below each of the flap, the first sensor configured to detect the press and to trigger a corresponding signal.

13. The system of claim 11, wherein the bottom panel comprises a divider dividing the depression and correspondingly dividing the cut-through opening.

14. The system of claim 11, wherein the bottom panel comprises a second sensor configured to detect a press of a finger reaching into the depression and to trigger a corresponding signal.

15. The system of claim 14, wherein:
the signal corresponding to the first sensor is configured to roll down a window; and
the signal corresponding to the second sensor is configured to roll up a window.

16. A vehicle, comprising:
a top panel on a door of the vehicle, wherein:
the top panel comprises one or more cut-through openings and one or more flaps;
at least one side of the flap is edged by the cut-through opening;
the flap is configured to flex with respect to the top panel, in response to a press of the flap; and
at least one of the one or more cut-through openings is configured to accommodate one or more fingers.

17. The vehicle of claim 16, further comprising a bottom panel disposed below the top panel.

18. The vehicle of claim 17, wherein the bottom panel comprises a first sensor on its top surface below each of the flap, the first sensor configured to detect the press and to trigger a corresponding signal.

19. The vehicle of claim 17, wherein the bottom panel comprises a second sensor configured to detect a press of a finger reaching into a depression of the bottom panel and to trigger a corresponding signal.

20. The vehicle of claim 19, wherein:
the signal corresponding to the first sensor is configured to roll down a window of the door; and
the signal corresponding to the second sensor is configured to roll up the window.
